(19) United States
(12) Patent Application Publication
(10) Pub. No.: US 2003/0134935 A1
(43) Pub. Date: Jul. 17, 2003

(54) Traction enhancement composition

(76) Inventor: David C. Schirmer, Horsham, PA (US)

Correspondence Address: Michael G. Crilly, Esquire, 104 South York Road, Hatboro, PA, 19040, US

(21) Appl. No.: 10/133,090

(22) Filed: Apr. 26, 2002

Related U.S. Application Data
(60) Provisional application No. 60/349,112, filed on Jan. 16, 2002.

(51) Int. Cl. C08K 3/38; C08K 3/10

(52) U.S. Cl. 523/149; 524/404; 524/406

(57) ABSTRACT

The present invention is a composition comprised of an adhesive with particulate inclusions disposed within or along the adhesive. Adhesive/ceramic composition forms a thin, anti-skid layer along a wear surface. In preferred embodiments, adhesive is a self-leveling liquid hardening to form a flexible, compressible layer along a surface. Particulate is irregular-shaped or uniform-shaped ceramic particles. In alternate embodiments, composition is aerosolizable, thereby dispensable from a pressurized container.

### CROSS REFERENCE TO RELATED APPLICATIONS

None.

### FEDERALLY SPONSORED RESEARCH OR DEVELOPMENT

None.

### BACKGROUND OF THE INVENTION

1. Field of the Invention

The present invention generally relates to a composition applicable to an object to enhance traction characteristics. Specifically, the invention is a composition consisting of a flexible, compressible adhesive and ceramic particles applicable to a wear surface at room temperature.

2. Description of the Related Art

While traction enhancement devices and compositions are found in the related arts, they are difficult to apply and penalize the performance of modern, technically-advanced tires. For example, Clark in U.S. Pat. No. 3,276,501 describes and claims an anti-skid tire having a layer composed of sand, glue, and pitch. The composition is either heated and applied by brush or trowel onto a tire or integrated into a tread during fabrication. The composition forms a hard, durable anti-skid layer when cooled.

The Clark invention penalizes tire performance in three respects. First, the hard, durable anti-skid formulation degrades ride quality by providing a less-flexible, less-compressible layer than the underlying tire. Second, the hard, durable anti-skid formulation resists wear thereby maintaining its presence well beyond the need. Third, the pitch-based formulation frustrates the formation of a uniform-thickness layer critical to maintaining tire balance.

Furthermore, the Clark invention is adversely effected by environmental conditions and detrimental to the tire. The composition is subject to cracking and peeling at low temperatures and creep and flow at elevated temperatures. The reliance on hot pitch to facilitate application subjects the underlying tire structure to conditions that degrade tire integrity.

What is currently required is a composition improving traction without penalizing tire performance. What is also required is a composition that neither cracks, nor peels, nor creeps, nor flows over the operating temperatures of a typical tire. What is also required is a composition applicable at ambient conditions.

### SUMMARY OF THE INVENTION

The primary object of the present invention is to provide a flexible, compressible anti-skid composition thereby minimizing performance penalties. An object of the present is to provide a composition that resists cracking, peeling, creep, and flow over the operational temperatures of a tire. A further object of the invention is to provide an anti-skid composition that is quickly and easily applicable to an object without specialized equipment.

The present invention is a mixture of an adhesive and particulate, also referred to as grit. In preferred embodiments, particulate is dispersed within the adhesive such that the adhesive forms a continuous matrix surrounding particulate. In alternate embodiments, particulate is disposed along one surface of the adhesive layer. In yet other embodiments, adhesive/particulate composition is aerosolizable and thereby dispensable from a pressurize container, one example including an aerosol can.

Adhesive is a high-strength formulation forming a compressible, flexible layer when cured along a surface. In preferred embodiments, adhesive is self-leveling in its liquid state. Adhesive provides a temporary, yet durable bond between particulate and tire.

Particulate is comprised of ceramic particles sufficiently robust to resist deformation and wear when compressively loaded between two surfaces, such as a tire and a roadway. In preferred embodiments, particulate is a metal-diboride, a metal-boride, a metal-carbide, a metal-nitride, or a metal-oxide, wherein the metal is titanium, zirconium, aluminum, hafnium, chromium, tantalum, silicon, or boron. Particulate is comprised of irregular-shaped silicon carbide particles. However, particulate may consist of one or more uniform shapes.

Several advantages are noteworthy with the present invention. Composition facilitates the application of a thin, uniform layer along the wear surface of a tire thereby maintaining tire balance. Composition provides a flexible, compressible layer along a tire thereby maintaining tire performance characteristics. Composition neither peels or cracks at low temperatures nor creeps or flows at high temperatures. Composition is applied under ambient conditions and provides a temporary, wearable coating.

### BRIEF DESCRIPTION OF THE DRAWINGS

The invention will now be described in more detail, by way of example only, with reference to the accompanying drawings, in which:

FIG. 1 is a section view of tire tread showing composition composed of adhesive surrounding particulate.

FIG. 2 is a section view of tire tread showing composition composed of adhesive layer with particulate disposed along one surface.

FIG. 3 is a section view of exemplary tire with layer of traction enhancing composition.

FIG. 4 is a section view of tire with temporary cover having traction enhancing composition along one surface.

### REFERENCE NUMERALS

1 Tire

2 Exterior

5 Tread

6 Applique

8 Composition

9 Matrix

10 Particulate

### DESCRIPTION OF THE INVENTION

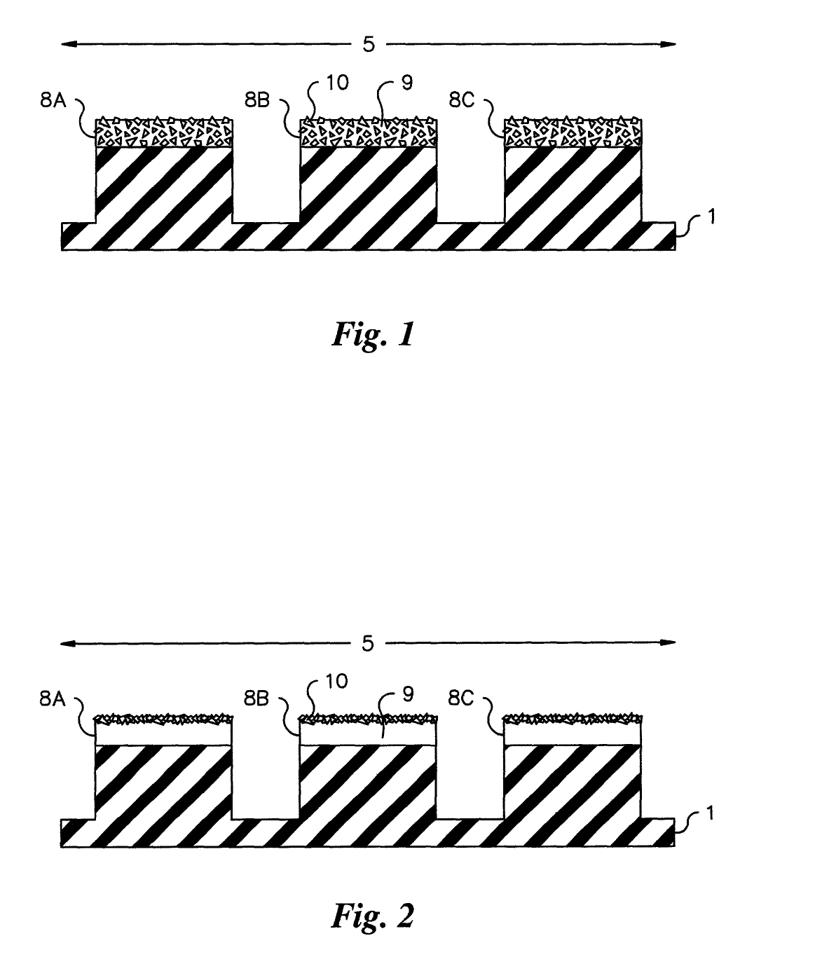

FIGS. 1 and 2 graphically describe embodiments of the composition 8. Composition 8 improves traction between a wear surface and a low-friction surface, including but not limited to water, snow, ice, and oil covered surfaces, by increasing frictional properties of the surface onto which it is bonded.

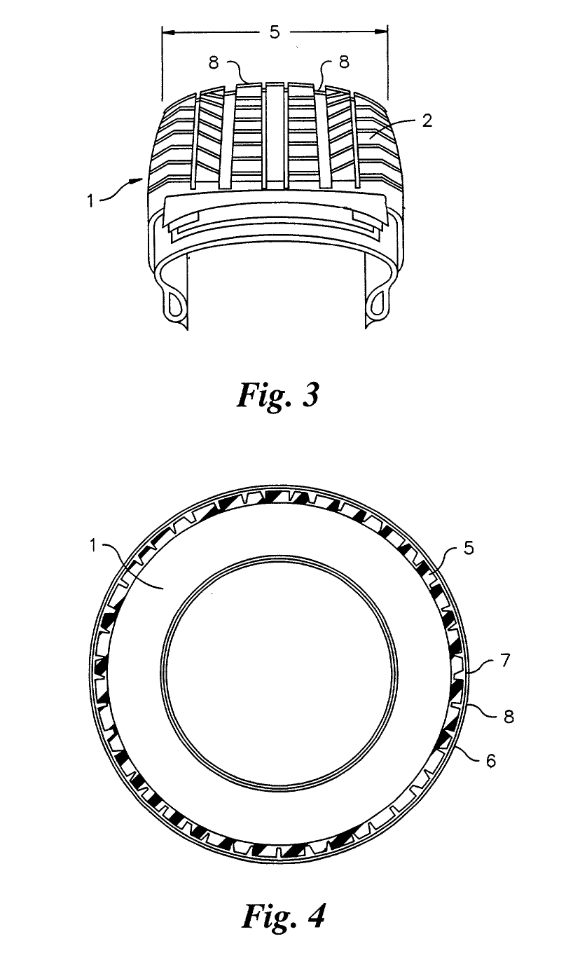

FIGS. 3 and 4 describe application of the present invention to an automobile tire 1. However, the present invention is equally applicable to aircraft, trucks, heavy equipment, motorcycles, shoes, boots, and drive belts.

The present invention is comprised of an adhesive and a particulate 10. When cured, adhesive forms a matrix 9 surrounding the particulate 10, as shown in FIG. 1, or a matrix 9 with particulate 10 disposed along one surface, as shown in FIG. 2. Particulate 10 enhances traction via friction or friction-like contacts with a lower-friction surface. In some embodiments, adhesive enhances traction by providing a more adherent surface than the underlying tire 1.

Adhesive bonds particulate 10 to tire 1 and prevents separation between particulate 10 and tire 1 during travel. However, both adhesive and particulate 10 slowly and evenly wear thereby exposing the original wear surface of the tire 1. The cured adhesive forms a matrix 9 having sufficient strength to maintain integrity of the matrix 9 and bond between particulate 10 and tire 1 during dynamic conditions. The bond strength of a typical, commercially-available rubber cement was adequate for applications involving small to medium size vehicles.

The hardness of a cured adhesive is indicative of its flexibility and compressibility. Performance penalties created by the composition 8 along a tire 1 are minimized by limiting the hardness differential between tire 1 and adhesive. While cured adhesives with a hardness greater than that of the tire 1 were adequate for many applications, preferred adhesives have a hardness no greater than the underlying structure.

Tire 1 balance is optimized by providing a uniform-thickness layer of composition 8 along the tire 1 length. Lower viscosity adhesives produced more a uniform thickness layer. Preferred adhesives are self-leveling liquids.

Adhesive type is application dependent. Specific commercially available adhesives included rubber-based, silicone-based, epoxy-based, latex-based, cyanoacrylate-based, styrene-based, and polyurethanurea-formulations. Preferred embodiments were composed of rubber-based, styrene-based, and two-part polyurethanurea formulations. Most preferred embodiments were composed of E-6000 manufactured by Eclectic Products, Inc., and commercially sold under the trademark Goop®. E-6000 is both waterproof and corrosion resistant having a tensile strength of approximately 2900 psi a minimum elongation of 600 percent, and an operational temperature range from −40° to 150° Fahrenheit.

Particulate 10 matter is typically composed of a plurality of ceramic-based particles, preferably irregular in shape, however other geometric shapes including spheres are acceptable. Particulate 10 should be sufficiently strong to maintain particle integrity during cyclically repeating compressive loads. Ceramic materials include metal-carbides, metal-diborides, metal-borides, metal-oxides, and metal-nitrides. Preferred ceramics include boron carbide, silicon carbide, tungsten carbide, silicon diboride, titanium diboride, aluminum oxide, and titanium dioxide. Particle size, morphology, and distribution are application dependent, however a particulate 10 composed of silicon carbide with commercial size of sixteen was preferred in automotive applications for improved traction on snow and ice.

The substructure of the composition 8 may take various forms. For example, particulate 10 may be suspended within a matrix 9 forming a layer wherein contact between particles is prevented by the matrix 9, as shown in FIG. 1. In another example, particulate 10 may be densely adhered along a surface of the composition 8, as shown in FIG. 2. Various structures are possible between the two examples.

FIG. 3 shows a representative tire 1 application wherein composition 8 is applied onto a tread 5. FIG. 4 shows an alternate application in which an applique 6, as understood in the art, is attached to a tire 1 via elastic cords or similar devices. One specific applique 6 consists of a thin rubber element having composition 8 applied along its outer surface and conformally attached to the exterior 2 of a tire 1.

Proper adherence of composition 8 to an object is achieved by cleaning the surface onto which composition 8 is applied. In some applications, it may be necessary to roughen the surface with a coarse material, one example including sandpaper. The composition 8 is applied at room temperature either separately, adhesive then particulate 10, or in composition 8 form. Composition 8 form is achieved by uniformly dispersing particulate 10 within the adhesive in its liquid state via various mixing techniques understood in the art.

In an alternate embodiment, adhesive and particulate 10 are applied to a surface in composition 8 form or separately via aerosolization. When applied via aerosolization, adhesive is dispensed from a pressurized spray container or similar type device and particulate 10 is dispensed from a second similar device. Alternately, composition 8 may be dispensed from a single aerosol device.

Both adhesive and particulate 10 properties are based on the performance characteristics of the dispenser. For example, higher pressurization facilitates the aerosolization of a more viscous adhesive. Additionally, nozzle size limits the size and shape of particulate 10.

Adhesive and particulate 10 may be applied separately or as a composition 8 via techniques known within the art. When applied separately, adhesive is leveled prior to application of particulate 10. Adhesive is cured after application of the particulate 10, thereby forming a flexible coating.

The invention is further described in the following example, provided by way of illustration, and not to be construed as limiting.

### EXAMPLE

A composition 8 composed of silicon carbide particulate 10 and liquid E-6000 adhesive sold under the trademark Goop® were mixed in equal mass fractions in a standard electric powered mixer until particulate 10 was uniformly distributed throughout the adhesive. Particulate 10 consisted of a grit with a commercial size of sixteen and irregular in shape. The composition 8 had a pot life between five and ten minutes. Total cure time for a two millimeter thick layer was four hours.

The effective lifetime of the composition 8 was approximately three hundred miles consisting of one hundred miles was along snow covered asphalt and two hundred along asphalt.

What is claimed is:

1. A composition for enhancing traction along a surface comprising:
(a) an adhesive forming a flexible, compressible layer when cured, said adhesive of sufficient strength to maintain integrity of said flexible, compressible layer when compressively loaded; and
(b) a ceramic-based particulate disposed within said adhesive, said ceramic-based particulate bonded to said surface by said adhesive.

2. The composition of claim 1, wherein said adhesive is a styrene-based formulation, a rubber-based formulation, or a two-part polyurethaneurea formulation.

3. The composition of claim 1, wherein said adhesive has an operating temperature range from −40 to 150 degrees Fahrenheit.

4. The composition of claim 1, wherein said adhesive is a self-leveling liquid.

5. The composition of claim 1, wherein said ceramic-based particulate is a metal-carbide, a metal-diboride, a metal-boride, a metal-oxide, or a metal-nitride.

6. The composition as in one of claims 1-5, wherein said composition is aerosolizable.

7. A composition for enhancing traction along a surface comprising:
(a) an adhesive forming a flexible, compressible layer when cured, said adhesive of sufficient strength to maintain integrity of said flexible, compressible layer when compressively loaded; and
(b) a ceramic-based particulate disposed along said adhesive, said ceramic-based particulate bonded to said surface by said adhesive.

8. The composition of claim 7, wherein said adhesive is a styrene-based formulation, a rubber-based formulation, or a two-part polyurethaneurea formulation.

9. The composition of claim 7, wherein said adhesive has an operating temperature range from −40 to 150 degrees Fahrenheit.

10. The composition of claim 7, wherein said adhesive is a self-leveling liquid.

11. The composition of claim 7, wherein said ceramic-based particulate is a metal-carbide, a metal-diboride, a metal-boride, a metal-oxide, or a metal-nitride.

12. The composition as in one of claims 7-11, wherein said ceramic-based particulate is separately aerosolizable from said adhesive.
